(19) United States
(12) Patent Application Publication
(10) Pub. No.: US 2026/0219891 A1
(43) Pub. Date: Jul. 30, 2026

(54) PREDICTION CIRCUITRY

(71) Applicant: Arm Limited, Cambridge (GB)

(72) Inventors: Alexander Cole SHULYAK, Austin, TX (US); Robert Douglas CLANCY, Apex, NC (US)

(21) Appl. No.: 19/038,885

(22) Filed: Jan. 28, 2025

(51) Int. Cl. G06F 9/38; G06F 9/345

(52) U.S. Cl. CPC G06F 9/3832; G06F 9/3455

(57) ABSTRACT

There is provided an apparatus comprising processing circuitry to perform data processing in response to a sequence of instructions. The apparatus comprises occurrence count circuitry to store an occurrence count indicative of a number of repeated occurrences of portions of the sequence of instructions. The apparatus comprises pattern storage circuitry to store a plurality of pattern entries, each pattern entry of the plurality of pattern entries associated with an instruction of the sequence of instructions and comprising a parameter for parameterising a relationship correlating the occurrence count with a value associated with the instruction. The apparatus comprises prediction circuitry responsive to receipt of a given occurrence of the instruction associated with a particular pattern entry, to predict the value associated with the given occurrence based on the relationship parameterised using the at least one parameter comprised in the particular pattern entry and the occurrence count for the given occurrence.

### TECHNICAL FIELD

The present invention relates to data processing. More particularly the present invention relates to an apparatus, a system, a chip-containing product, a method, and a computer-readable medium.

### BACKGROUND

Some apparatuses are provided with prediction circuitry responsive to receipt of an instruction to predict a value associated with the instruction.

### SUMMARY

According to a first aspect of the present techniques there is provided an apparatus comprising:
processing circuitry configured to perform data processing in response to a sequence of instructions;
occurrence count circuitry configured to store an occurrence count indicative of a number of repeated occurrences of one or more portions of the sequence of instructions;
pattern storage circuitry configured to store a plurality of pattern entries, each pattern entry of the plurality of pattern entries associated with an instruction of the sequence of instructions and comprising at least one parameter for parameterising a relationship correlating the occurrence count with a value associated with the instruction; and
prediction circuitry responsive to receipt of a given occurrence of the instruction associated with a particular pattern entry of the plurality of pattern entries, to predict the value associated with the given occurrence of the instruction based on the relationship parameterised using the at least one parameter comprised in the particular pattern entry and the occurrence count for the given occurrence.

According to a second aspect of the present techniques there is provided a system comprising:
the apparatus according to the first aspect, implemented in at least one packaged chip;
at least one system component; and
a board,
wherein the at least one packaged chip and the at least one system component are assembled on the board.

According to a third aspect of the present techniques there is provided a chip-containing product comprising the system according to the second aspect, wherein the system is assembled on a further board with at least one other product component.

According to a fourth aspect of the present techniques there is provided a method comprising:
performing data processing in response to a sequence of instructions;
storing an occurrence count indicative of a number of repeated occurrences of one or more portions of the sequence of instructions;
storing a plurality of pattern entries, each pattern entry of the plurality of pattern entries associated with an instruction of the sequence of instructions and comprising at least one parameter for parameterising a relationship correlating the occurrence count with a value associated with the instruction; and
in response to receipt of a given occurrence of the instruction associated with a particular pattern entry of the plurality of pattern entries, predicting the value associated with the given occurrence of the instruction based on the relationship parameterised using the at least one parameter comprised in the particular pattern entry and the occurrence count for the given occurrence.

According to a fifth aspect of the present techniques there is provided a non-transitory computer-readable medium storing computer-readable code for fabrication of an apparatus comprising:
processing circuitry configured to perform data processing in response to a sequence of instructions;
occurrence count circuitry configured to store an occurrence count indicative of a number of repeated occurrences of one or more portions of the sequence of instructions;
pattern storage circuitry configured to store a plurality of pattern entries, each pattern entry of the plurality of pattern entries associated with an instruction of the sequence of instructions and comprising at least one parameter for parameterising a relationship correlating the occurrence count with a value associated with the instruction; and
prediction circuitry responsive to receipt of a given occurrence of the instruction associated with a particular pattern entry of the plurality of pattern entries, to predict the value associated with the given occurrence of the instruction based on the relationship parameterised using the at least one parameter comprised in the particular pattern entry and the occurrence count for the given occurrence.

### BRIEF DESCRIPTION OF THE DRAWINGS

The present invention will be described further, by way of example only, with reference to configurations thereof as illustrated in the accompanying drawings, in which:

FIG. 1 schematically illustrates an apparatus according to some configurations of the present techniques;

FIG. 2 schematically illustrates an apparatus according to some configurations of the present techniques;

FIG. 3 schematically illustrates an apparatus according to some configurations of the present techniques;

FIG. 4 schematically illustrates a sequence of steps carried out according to some configurations of the present techniques;

FIG. 5 schematically illustrates an example of a predicted value according to some configurations of the present techniques;

FIG. 6 schematically illustrates an example of a predicted value according to some configurations of the present techniques;

FIG. 7 schematically illustrates a sequence of steps carried out according to some configurations of the present techniques;

FIG. 8 schematically illustrates an example of increasing a confidence according to some configurations of the present techniques;

FIG. 9 schematically illustrates an example of decreasing a confidence according to some configurations of the present techniques;

FIG. 10 schematically illustrates a sequence of steps according to some configurations of the present techniques; and

FIG. 11 schematically illustrates a system and a chip-containing product according to some configurations of the present techniques.

### DESCRIPTION OF EXAMPLE CONFIGURATIONS

Before discussing the configurations with reference to the accompanying figures, the following description of configurations is provided.

Prediction of values, including the prediction of addresses represented by values, can be carried out by various structures in some apparatuses. For example, prefetch circuitry may predict values of future addresses from which data is to be loaded in advance of that data (including data representative of an instruction or of instructions) being required by the apparatus. In the case of prefetching, any inaccuracy in the algorithm does not significantly affect processing. Whilst a misprediction when prefetching may result in a data value not being present when it is needed, the result of this absence is that the data is fetched and no benefit of the prefetching is observed.

In contrast, some prediction circuits predict values to be used by the apparatus during processing by processing circuitry. In other words, for a given instruction, a value associated with that instruction (either a value resulting from execution of the instruction or a value used as an operand for the instruction) may be predicted and used by the processing circuitry and consumed by the processing circuitry when the given instruction is issued for execution. The cost of mispredicting such instructions can be much higher as the instruction (and any subsequently issued instructions) may need to be flushed from the processing circuitry and subsequently re-run. In general, it may not be possible to completely eliminate mispredictions. However, the relative cost of mispredictions can be mitigated if number of useful predictions can be increased relative to the number of mispredictions.

According to some configurations of the present techniques there is provided an apparatus comprising processing circuitry configured to perform data processing in response to a sequence of instructions. The apparatus is provided with occurrence count circuitry configured to store an occurrence count indicative of a number of repeated occurrences of one or more portions of the sequence of instructions. The apparatus is provided with pattern storage circuitry configured to store a plurality of pattern entries, each pattern entry of the plurality of pattern entries associated with an instruction of the sequence of instructions and comprising at least one parameter for parameterising a relationship correlating the occurrence count with a value associated with the instruction. The apparatus is also provided with prediction circuitry responsive to receipt of a given occurrence of the instruction associated with a particular pattern entry of the plurality of pattern entries, to predict the value associated with the given occurrence of the instruction based on the relationship parameterised using the at least one parameter comprised in the particular pattern entry and the occurrence count for the given occurrence.

The sequence of instructions includes instructions defined in an instruction set architecture. The instruction set architecture comprises a complete set of instructions that can be interpreted by the processing circuitry and may include instructions to interact with a memory system and instructions to combine and/or modify data retrieved from the memory system. During operation, the sequence of instructions received by the processing circuitry may include one or more instructions for which a value prediction may be appropriate. For example, value prediction may be performed for a certain type of instruction, e.g., memory access instructions, or a particular set of predefined instructions.

In order to facilitate the value prediction, the apparatus is provided with pattern storage circuitry to store plural pattern entries. Each of the pattern entries is associated with an instruction, for example, the pattern entries may be stored in a table indexed based on a program counter value (or an instruction pointer value) associated with the instruction (e.g., indexed using a portion of the program counter value, a hash of the program counter value, or a hash of a portion of the program counter value). Each pattern entry defines, for the associated instruction, a pattern of values associated with that instruction. The pattern entry is used, in response to receipt of the instruction associated with that pattern, to enable the prediction circuitry to predict the value for that instruction. In order to make a prediction, the prediction circuitry needs to know the pattern of values to expect along with a position within that pattern for each occurrence of the instruction that is received. It may be theoretically possible to define where a current instance of an instruction falls within the pattern using a pending count, i.e., a count indicative of a how many instances of the instruction are currently being processed by the processing circuitry and an indication of a position within the pattern of a completed instruction. However, the inventors have recognised that there are a number of downsides to this approach.
First, to properly maintain the pending count in the event of a flush, each pattern entry would have to be provided with its own pending count which would have to be “recoverable” in the event of a flush. This would require a significant amount of circuit area and power consumption. Alternatively, the pending count could be made non-recoverable. However, this would mean that, subsequent to a flush, it would not be possible to predict values associated with an instruction until an instance of the instruction has completed execution.
Second, the pending count must be updated in order. For an out of order circuit, this would require an in-order buffer to be added to track the load values until retire time resulting in a large area cost.
Third, the sequence of instructions may intermittently skip an instance of the instruction. For example, in some use cases, the sequence of instructions may comprise a loop in which an address is constantly implemented without skipping, but the load that uses that address may be guarded, e.g., by a branch instruction, causing the load to be skipped on some iterations. The address of the load instruction may therefore be correlated to the iteration of the loop but not to the instances observed by the processing circuitry. This type of behaviour would be very difficult to predict accurately.

The inventors have realised that the above downsides can be overcome by correlating the load value with an identifier that is updated provide a value that is unique to each specific occurrence of the instruction. In particular, there is provided occurrence count circuitry that stores an occurrence count. The occurrence count indicates a number of repeat occurrences of one or more portions of the sequence. The occurrence count therefore provides an identifier that updates between repeated occurrences of an instruction having a same program counter value. In other words, each time a portion of the sequence of instructions repeats, the occurrence count is updated to indicate the repetition of that portion of the sequence. Therefore, the occurrence count value provided for two different instances of an instruction having a same program counter value will be different.

The pattern entries in the pattern storage circuitry are configured to comprise at least one parameter that parameterises a relationship between the occurrence count and a value associated with the instruction. The relationship, parameterised by the at least one parameter, correlates the occurrence count value with the value associated with the instruction. In other words, when the instruction is identified, e.g., by a program counter value or an instruction pointer value, the value for that instruction can be predicted from the occurrence count value using the relationship parameterised by the at least one parameter stored in the pattern entry for the instruction.

The prediction circuitry is arranged to receive instructions and, in response to receipt of the instruction, to determine a particular pattern entry associated with that instruction. The pattern entry is then used to parameterise the relationship. The prediction circuitry is configured to use the parameterised relationship, taking the occurrence count as an input operand, to predict the value associated with that instruction. The instruction and the predicted value can then be passed for execution by the processing circuitry. The predicted value for a given occurrence of the instruction is predicted (e.g., is calculated or determined) in response to receipt of the given occurrence of the instruction. In other words, before the given occurrence of the instruction is received by the prediction circuitry, the value is unknown. Therefore, whilst the at least one parameter used to parameterise the relationship may be derived based on previous instances of the instruction, the prediction itself is not carried out until receipt of the given occurrence of the instruction.

Performing the prediction based on the occurrence count has several advantages. First, the occurrence count is a single value and, as such, the cost of making the occurrence count recoverable in response to a flush is much lower than in the case of using the pending count (which would have to be provided for each prediction entry). Second, the occurrence count is indicative of the particular instance (occurrence) of the instruction. Hence, the use of the occurrence count inherently supports out of order execution. Third, the occurrence count is correlated with the particular instance of the instruction, rather than the number of times a particular instruction is observed by the processing circuitry. Hence, the occurrence count would inherently be able to keep track of guarded instances of the instruction.

In some configurations the processing circuitry comprises front end circuitry configured to receive the sequence of instructions in program order and to associate each instruction of the sequence of instructions with a tag value determined based on the occurrence count at the point at which that instruction is received. This association of an instruction with the tag value could be provided in different ways. In one example the instruction may pass down a processing pipeline accompanied by the corresponding tag value, so that the tag value can be identified when the instruction reaches the execute stage of the pipeline. Alternatively, rather than the tag value passing along the pipeline together with the instruction, instead the association between a particular instruction identifier identifying the instruction and the corresponding tag value could be recorded in a separate storage structure, to reduce the size of the signal paths which convey the instruction down the pipeline itself.

In some configurations the prediction circuitry is comprised in the front end circuitry. For example, the prediction circuitry may be provided in a fetch stage, a decode stage, or an issue stage of the pipeline.

In some configurations the apparatus comprises recovery circuitry responsive to a flush of currently executing instructions from the processing circuitry, to restore the occurrence count value stored in the pattern storage circuitry to a restored occurrence count value determined based on the tag value associated with a sequentially first instruction to be issued for execution subsequent to the flush. By restoring the occurrence count value based on the tag value, this effectively rewinds the occurrence count to the point before the flush, i.e., the sequentially first instruction to be issued for execution subsequent to the flush. As a result, the occurrence count value available to the prediction circuitry subsequent to the flush is representative of a current point in the execution of the sequence of instructions.

In some configurations the prediction circuitry is configured to commence predicting when the sequentially first instruction is issued for execution. Because the occurrence count value is rewound to the value of the sequentially first instruction to be issued for execution, the occurrence count value can accurately be used in the relationship to predict a value. In other words, because the occurrence count value remains representative of the current point in the execution of the sequence of instructions, there is no warm up period required for the prediction circuitry to determine a relative position in the relationship. As a result, a greater number of values can be predicted by the prediction circuitry resulting in an overall reduction in latency.

In some configurations the processing circuitry is responsive to a completed instruction of the sequence of instructions, to perform a lookup in the pattern storage circuitry based on the completed instruction and, in response to the lookup resulting in a hit in the pattern storage circuitry, to update the at least one parameter comprised in the pattern entry that resulted in the hit. Updating the at least one parameter in this way ensures that the parameterisation of the relationship is kept up to date as the sequence of instructions progresses.

In some configurations the at least one parameter comprises at least one of: the tag value associated with the completed instruction; and the value associated with the completed instruction. The at least one parameter may also include, for example, an indication of a tag value delta (a difference between tag values) observed for an occurrence count delta. In some configurations updating the at least one parameter value comprises updating all of the parameters comprised in the pattern entry. In some configurations updating the at least one parameter value comprises updating only a subset of the parameters. In some configurations the at least one parameter comprises a correlation between a previous value associated with a previous occurrence of the instruction and a previous occurrence count associated with the previous occurrence.

The relationship may be any relationship that can be used to correlate the occurrence count with the predicted value. In some configurations the relationship is suitable for predicting, as the value, a new value not included in a set of previously observed values associated with the instruction. The prediction circuitry is configured to use the relationship to predict new members in the sequence of values that have not been observed before. For example, the sequence of values predicted by the prediction circuitry may be a non-repeating pattern, e.g., a monotonically increasing pattern, a monotonically decreasing pattern, or a pattern comprising some previously observed values and some values that have not previously been observed. In other words, the relationship is a relationship other than a repeating sequence of values. Whilst the values predicted as a result of the relationship may be bound within a range, in some configurations the relationship is suitable for extrapolating the new value beyond a range of the previously observed values.

In addition, or as an alternative, to predicting values not previously observed when processing the instruction, in some configurations the relationship is suitable for extrapolating the value over at least one occurrence count value beyond occurrence count values previously stored in the occurrence count circuitry. The prediction circuitry is therefore capable of predicting for occurrence count values not previously observed. In general, the relationship correlating the occurrence count with the value is considered to be any relationship that, when parameterised by the pattern entry, maps any occurrence count value (including previously unseen occurrence count values) onto a value where the mapping is defined such that the value is not constrained to previously observed values.

In some configurations the relationship comprises a mathematical relationship between the occurrence count and the value. The mathematical relationship may be an arithmetic relationship, or a logical relationship.

Whilst the mathematical relationship may be a non-linear relationship, in some configurations the mathematical relationship is a linear relationship. The linear relationship may be a linear relationship defined over the full range of occurrence count values. Alternatively, the linear relationship may be a piecewise linear relationship. For example, in some configurations the linear relationship comprises a linearization about a previously observed occurrence of the instruction associated with the particular pattern entry.

In some configurations the prediction circuitry is stride prediction circuitry and the linear relationship has a gradient equal to an observed stride length between consecutive occurrences of the instruction. The stride length may be recorded during a training period based on observation of a number of iterations of the instruction. The stride length may be expressed as a change in the value to be predicted per unit change in the occurrence count. Once the stride prediction has been trained, the linear relationship can be used to calculate the value from the occurrence count. For example, at least one parameter associated with a given instruction may include the stride length along with an indication of a previous value and a previous occurrence count for which the previous value was observed. By comparing the previous occurrence count with the given occurrence count in response to receipt of a given occurrence of the instruction, a delta value indicative of the difference between the given occurrence count and the previous occurrence count can be calculated. The stride length can then be multiplied by that difference and added to the previous value to determine the new value. It will be readily apparent to the skilled person that more complex strides could be supported using a different relationship, for example, a nested stride pattern could be supported by correlating the occurrence count value to a position in the nested stride pattern and tracking each stride length and stride counter associated with the nested stride pattern.

The occurrence count value can be implemented in a variety of ways. However, in some configurations the occurrence count circuitry is configured to increment the occurrence count in response to a detection of a backwards change of program flow indicative of a change of program flow from a first instruction to a second instruction having a lower instruction address than the first instruction. The occurrence count, which may also be referred to as a loop count, therefore provides a different value for each occurrence of an instruction having a same program counter value. For example, an instruction for which a prediction is being made is comprised in a loop of the type:

```
For(i : range (array)) {
  If a[i] > 10) {
    a[i] += b[i];
  }
}
```

Here, the counter i is incremented to index each element in an array. Then, based on whether a value a[i] meets a condition, the value b[i] is accumulated into a[i]. It is assumed that the values b[i] follow a pattern that can be predicted, for example, a strided pattern where sequential elements b[i] and b[i+1] are separated by a fixed stride length. In this example, the occurrence count will increment for each backwards branch, i.e., each iteration of a loop, thereby ensuring that changes in the value of the occurrence count are equal to changes in the counter i (although the absolute value of i may differ from the occurrence count dependent on the initial value the occurrence count). Correlating the value, for example, b[i] with the occurrence count enables b[i] to be predicted as f[CNT], where CNT is the occurrence count and f is a relationship defined by the predictor such that b[i]=f[CNT]. Because the occurrence count is indicative of the actual loop iteration, this approach will enable the predictor to accurately predict the values of b[i] regardless of the actual execution order of the instructions and regardless of how many of the accumulation operations are skipped due to the presence of the if statement.

In some configurations the instruction is a memory access instruction and the value is one of: at least a portion of an address to be used by the memory access instruction to retrieve content from memory; and content to be loaded in response to the memory access instruction. Typically, memory access instructions have a longer latency that other instructions (e.g., arithmetic or logical instructions) due to the time requirements for address translation and retrieval of the data from a memory hierarchy. Whilst prefetching techniques and address translation caching techniques can be used to hide this latency, further optimisation can be obtained by predicting the values using the techniques described herein. In some configurations the address to be used by the memory access instruction may relate to content loaded (or to be loaded) from a preceding memory access instruction.

Particular configurations will now be described with reference to the figures.

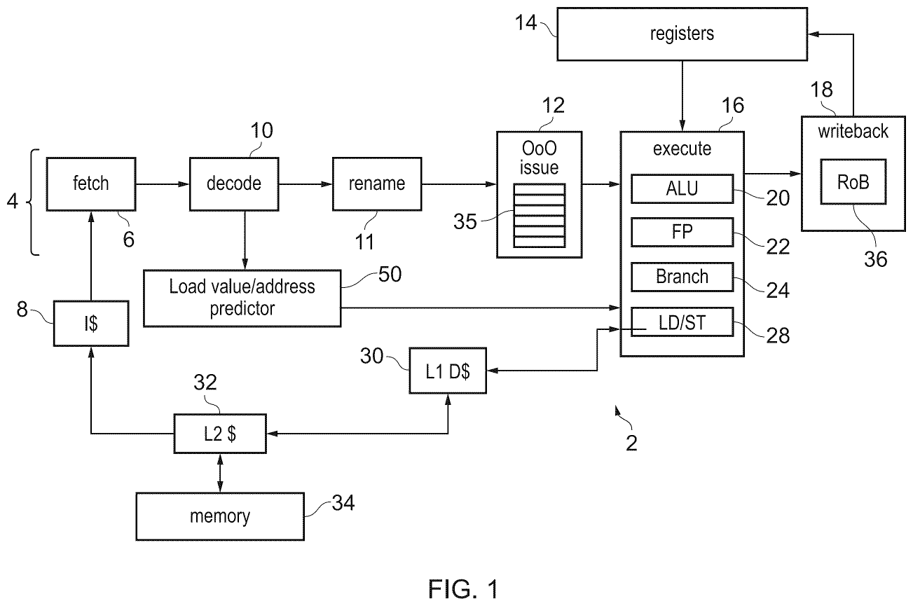

FIG. 1 schematically illustrates an example of a data processing apparatus 2. The data processing apparatus has a processing pipeline 4 which includes a number of pipeline stages. In this example, the pipeline stages include a fetch stage 6 for fetching instructions from an instruction cache 8; a decode stage 10 for decoding the fetched program instructions to generate micro-operations to be processed by remaining stages of the pipeline; a register renaming stage 11 for mapping architectural registers specified by program instructions or micro-operations to physical register specifiers identifying physical registers in a register file 14; an issue stage 12 for checking whether operands required for the micro-operations are available in a register file 14 and issuing micro-operations for execution once the required operands for a given micro-operation are available; an execute stage 16 for executing data processing operations corresponding to the micro-operations, by processing operands read from the register file 14 to generate result values; and a writeback stage 18 for writing the results of the processing back to the register file 14. It will be appreciated that this is merely one example of possible pipeline architecture, and other systems may have additional stages or a different configuration of stages.

The execute stage 16 includes a number of processing units, for executing different classes of processing operation. For example the execution units may include a scalar arithmetic/logic unit (ALU) 20 for performing arithmetic or logical operations on scalar operands read from the registers 14; a floating point unit 22 for performing operations on floating-point values; a branch unit 24 for evaluating the outcome of branch operations and adjusting the program counter which represents the current point of execution accordingly; and a load/store unit 28 for performing load/store operations to access data in a memory system 8, 30, 32, 34.

In this example, the memory system includes a level one data cache 30, the level one instruction cache 8, a shared level two cache 32 and main system memory 34. It will be appreciated that this is just one example of a possible memory hierarchy and other arrangements of caches can be provided. The specific types of processing unit 20 to 26 shown in the execute stage 16 are just one example, and other implementations may have a different set of processing units or could include multiple instances of the same type of processing unit so that multiple micro-operations of the same type can be handled in parallel. It will be appreciated that FIG. 1 is merely a simplified representation of some components of a possible processor pipeline architecture, and the processor may include many other elements not illustrated for conciseness.

The processor shown in FIG. 1 is an out-of-order processor where the pipeline 4 includes a number of features supporting out-of-order processing. This includes the issue stage 12 having an issue queue 35 for queuing instructions and issue control circuitry which is able to issue a given instruction for execution if its operands are ready, even if an earlier instruction in program order has not issued yet. Also the writeback stage 18 may include a reorder buffer (rob) 36 which tracks the execution and the commitment of different instructions in the program order, so that a given instruction can be committed once any earlier instructions in program order have themselves be committed. Also, the register renaming stage 11 helps to support out of order processing by remapping architectural register specifiers specifying the instructions decoded by the decode stage 10 to physical register specifiers identifying physical registers 14 provided in hardware. The instruction encoding may only have space for a register specifiers of a certain limited number of bits which may restrict the number of architectural registers supported to a relatively low number such as 16 or 32. This may cause register pressure, where after a certain number of instructions have been processed a later instruction which independent of an earlier instruction which references a particular register needs to reuse that register for storing different data values. In an in-order processor, that later instruction would need to wait until the earlier reference to the same register has completed before it can proceed, but these register dependencies caused by insufficient number of architectural registers can be avoided in an out-of-order processor by remapping the references to the same destination register in different instructions to different physical registers within the register file 14, which may comprise a greater number of physical registers than the number of architectural registers supported in the instruction encoding. This can allow a later instruction which writes to a particular architectural register to be executed while an earlier instruction which writes to the same architectural register is stalled, because those register references are mapped to different physical registers in the register file 14. It will be appreciated that other features may support out of order processing.

As shown in FIG. 1, the apparatus 2 comprises a load value or load address predictor 50. The load value or load address predictor is provided for predicting data values to be loaded in response to load instructions executed by the load/store unit 28 and/or predicting load addresses from which the data values are to be loaded before the operands for calculating the load addresses have been determined. For example, the load value/address predictor 50 may comprise pattern storage circuitry configured to store a plurality of pattern entries. Each of the plurality of pattern entries may be configured to associate an instruction with one or more parameters for parameterising a relationship correlating an occurrence count (for example, a loop count as described above) with a value associated with the instruction. The load value/address predictor 50 is coupled to the decode circuitry 10 and is responsive to receipt of an instruction to perform a lookup in the pattern storage circuitry to determine if the instruction is identified in one of the pattern entries. The load value/address predictor 50 is responsive to a hit in the pattern storage circuitry to predict a value associated with the instruction, for example a value to be loaded or an address value and to pass that value to the execution circuitry 16. Whilst the load value/address predictor 50 is illustrated as receiving an indication of the instructions from the decode circuitry 10, it will be appreciated that the load value/address predictor 50 could receive the indication of the indication of the instructions from any of the units comprised in the front end of the pipeline, e.g., fetch circuitry 6, decode circuitry 10, or rename circuitry 12. Furthermore, the load value/address predictor 50 could output the predicted values to the registers 14 or to a dedicated storage structure (not illustrated) for subsequent use by the execution circuitry 16.

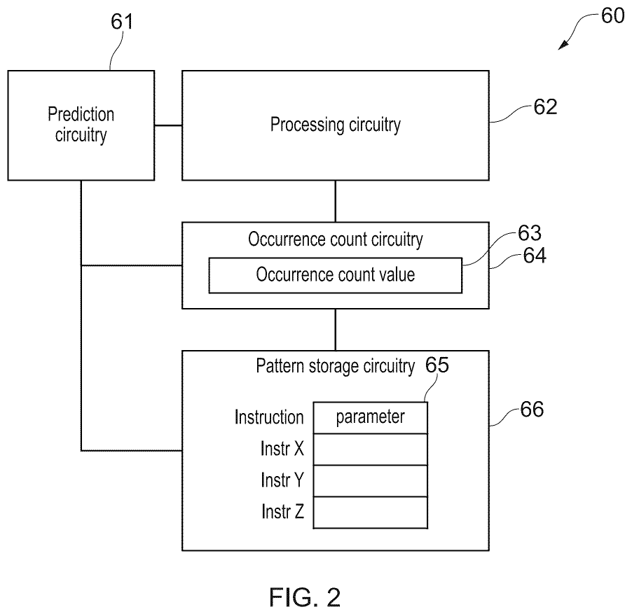

FIG. 2 schematically illustrates an apparatus 60 according to some configurations of the present technique. The apparatus 60 is provided with prediction circuitry 61, processing circuitry 62, occurrence count circuitry 64, and pattern storage circuitry 66. The processing circuitry 62 is configured to process a sequence of instructions and may be arranged, for example, as the processing pipeline 4 described in relation to FIG. 1. The occurrence count circuitry 64 is configured to store an occurrence count value 63. The occurrence count value 63 is indicative of a number of repeated occurrences of one or more portions of the sequence of instructions processed by the processing circuitry 62. In particular, the occurrence count circuitry 64 may be configured to update the occurrence count value 63 in response to a backwards taken branch in the sequence of instructions. The pattern storage circuitry 66 is configured to store a plurality of pattern entries 65. Each of the plurality of pattern entries is associated with an instruction and may be identified, for example, by a program counter value associated with the instruction, an instruction pointer value associated with the instruction, and/or a hash of at least a portion of a program counter value or an instruction pointer. The pattern entries 65 each store at least one (i.e., one or more) parameter associated with the instruction. The parameters stored in the plurality of pattern entries 65 are used to parameterise a relationship that can be used, by the prediction circuitry 61, to predict a value associated with the instruction.

The prediction circuitry 61 is responsive to receipt of a given instruction to be processed by the processing circuitry 62 to perform a lookup in the pattern storage circuitry 66 to identify whether the instruction is identified in a pattern entry 65 stored in the pattern storage circuitry. When the lookup results in a hit, the prediction circuitry 61 receives the parameters stored in the pattern entry 65 that resulted in the hit and parameterises the relationship based on those parameters. The prediction circuitry 61 then predicts the value based on the relationship parameterised by those parameters. The value predicted by the prediction circuitry 61 is provided to the processing circuitry 62 to use when processing the instruction, e.g., to be used as an address when performing a load defined in an instruction or to be used as a value returned from a load.

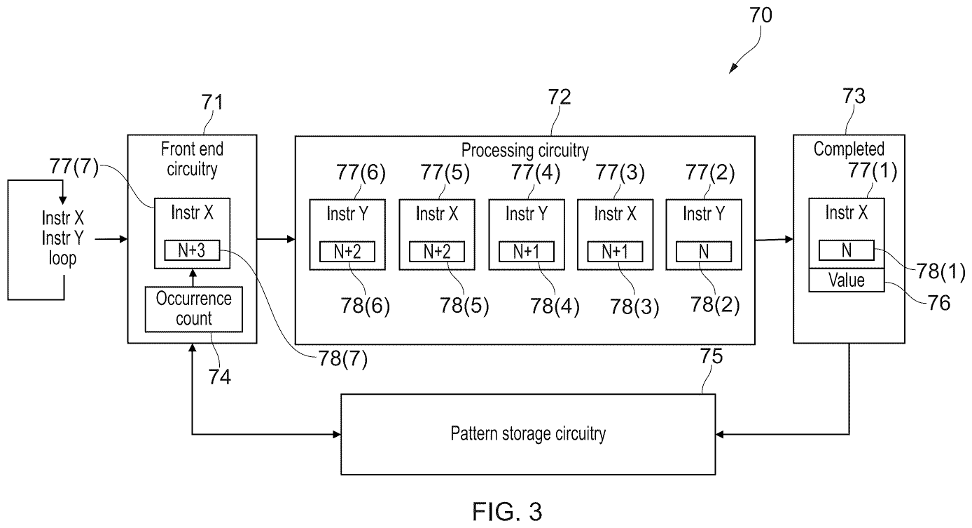

FIG. 3 schematically illustrates an example of a sequence of instructions being processed by an apparatus 70 according to some configurations of the present techniques. The apparatus 70 is provided with front end circuitry 71, processing circuitry 72, and storage circuitry 73 to store completed instructions prior to the results of those instructions being committed. The apparatus 70 is also provided with pattern storage circuitry 75. The front end circuitry 71 is configured to operate as prediction circuitry and comprises occurrence count circuitry 74 configured to store an occurrence count. The processing circuitry 72 is arranged as a processing pipeline and is configured to process a sequence of instructions 77 which progress sequentially along the processing pipeline. Once instructions of the sequence of instructions 77 are completed, they are stored in the storage circuitry 73 to be subsequently committed to storage.

In the illustrated configurations the front end circuitry 71 receives a repeated sequence of instructions 77 that comprise a first instruction: Instr X having a first program counter value, and a second instruction: Instr Y having a second program counter value. Either or both of the instructions InstrX and Instr Y may be instructions for which a value can be predicted. The instructions 77 are repeated according to a loop. The loop causes a non-sequential change in the flow of instructions, i.e., a program counter or instruction pointer identifying the next instruction to be executed is decreased. In the illustrated configuration, the instructions 77 are received by the front end circuitry and are tagged with a tag value 78 indicative of the occurrence count. The tag value 78 is associated with the instructions 77 as the instructions proceed down the processing pipeline in the processing circuitry 72. In the illustrated configuration, a first instruction 77(1), which is a first occurrence of Instr X and is associated with a first tag value 78(1) equal to N has proceeded down the processing pipeline and is stored in the storage circuitry 73 along with a value 76 that is associated with the first instruction 77(1). A second instruction 77(2) which is a first occurrence of Instr Y and is associated with a second tag value 78(2) equal to N is being processed by a fifth stage of the processing pipeline. The second tag value 78(2) is equal to the first tag value 78(1) because there is no backwards branch between the first instance of Instr X and the first instance of Instr Y. A third instruction 77(3) which is a second occurrence of Instr X and is associated with a third tag value 78(3) equal to N+1 is being processed by a fourth stage of the processing pipeline. The third tag value 78(3) is not equal to the second tag value 78(2) because there is a backwards branch between the first instance of Instr Y and the second instance of Instr X. A fourth instruction 77(4) which is a second occurrence of Instr Y and is associated with a fourth tag value 78(4) equal to N+1 is being processed by a third stage of the processing pipeline. The fourth tag value 78(4) is equal to the third tag value 78(3) because there is no backwards branch between the second instance of Instr X and the second instance of Instr Y. A fifth instruction 77(5) which is a third occurrence of Instr X and is associated with a fifth tag value 78(5) equal to N+2 is being processed by a second stage of the processing pipeline. The fifth tag value 78(5) is not equal to the fourth tag value 78(4) because there is a backwards branch between the second instance of Instr Y and the third instance of Instr X. A sixth instruction 77(6) which is a third occurrence of Instr Y and is associated with a sixth tag value 78(6) equal to N+2 is being processed by a first stage of the processing pipeline. The sixth tag value 78(6) is equal to the fifth tag value 78(5) because there is no backwards branch between the third instance of Instr X and the third instance of Instr Y. A seventh instruction 77(7) which is a fourth occurrence of Instr X is received by the front end circuitry 71. Because of the backwards branch between the third occurrence of Instr Y 77(6) and the fourth occurrence of Instr X, the occurrence count has a value of N+3. The front end circuitry 71 tags the seventh instruction 77(7) with the occurrence count value 78(7) to be passed to the processing circuitry 72 in the next cycle.

The front end circuitry 71 is responsive to receipt of the seventh instruction 77(7) to trigger a lookup in the pattern storage circuitry 75 based on the program counter value associated with Instr X. Where the lookup results in a hit in the pattern storage circuitry 75, the front end circuitry 71 parameterises a relationship based on the parameters stored in the pattern entry that resulted in the hit and determines a value associated with the seventh instruction 77(7) based on a current value of the occurrence count 74. This value may be indicated to the processing circuitry to be used during processing of the seventh instruction 77(7). The storage circuitry 73 is responsive to completion of the first instruction 77(1) to update the pattern entry associated with instruction Instr X based on the first tag value 78(1) and the value 76 associated with the first instruction 77(1).

Because the tag values 78 are associated with the instructions 77 throughout the processing pipeline, the processing circuitry is able to respond to a flush, e.g., resulting from a misprediction, by rewinding the occurrence count. For example, if it turned out that the third instruction 77(3) was mispredicted, then the processing circuitry would have to flush the third instruction 77(3) and the subsequent instructions and re-execute these instructions. During the flush, the occurrence count value is reset to the third tag value 78(3), i.e., N+1. As a result, the occurrence count value can be used straight away in combination with the parameters stored in the pattern storage circuitry to predict values associated with the instructions. Because the third instruction 77(3) was mispredicted, the pattern entry stored in relation to instruction Instr X may have its confidence reduced so that predictions cannot be made in relation to that instruction. However, as there is no indication that predictions associated with Instr Y have been mispredicted, these values can be predicted as soon as the next instance of instr Y reaches the front end circuitry subsequent to the flush.

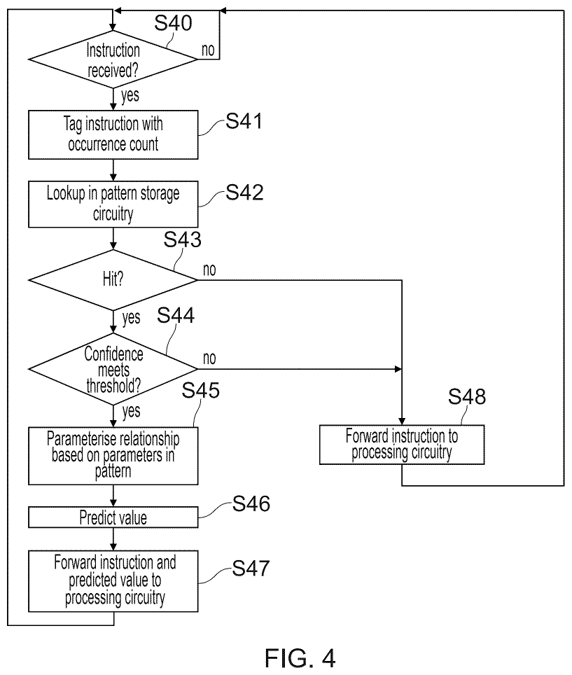

FIG. 4 schematically illustrates a sequence of steps performed in predicting a value for a given instruction. Flow begins at step S40 where it is determined if an instruction has been received. If, at step S40, it is determined that no instructions have been received, then flow remains at step S40. If, at step S40, it is determined that an instruction has been received, then flow proceeds to step S41 where the instruction is tagged with a current value of the occurrence count. Flow then proceeds to step S42 where a lookup is performed in the pattern storage circuitry to identify if there is a pattern entry associated with the received instruction. Flow then proceeds to step S43 where it is determined if the lookup resulted in a hit. If, at step S43, it is determined that the lookup did not result in a hit, then flow proceed to step S48 where the instruction is forwarded to processing circuitry, i.e., without a prediction being made, before flow returns to step S40. If, at step S43, it is determined that the lookup did result in a hit, then flow proceed to step S44 where it is determined if a confidence associated with the prediction entry meets a threshold. If, at step S44, it is determined that the confidence does not meet the threshold, then flow proceeds to step S48 and, subsequently, continues as described above. If, at step S44, it is determined that the confidence meets a threshold, then flow proceeds to step S45 where a relationship correlating the occurrence count with a value to be predicted is parameterised by parameters defined in the pattern entry that resulted in the hit. Flow then proceeds to step S46 where the relationship is used to predict a value associated with the instruction. Flow then proceeds to step S47 where the instruction and the predicted value are forwarded to processing circuitry to be processed based on the predicted value, i.e., using the predicted value in advance of the actual value being determined. Flow then returns to step S40.

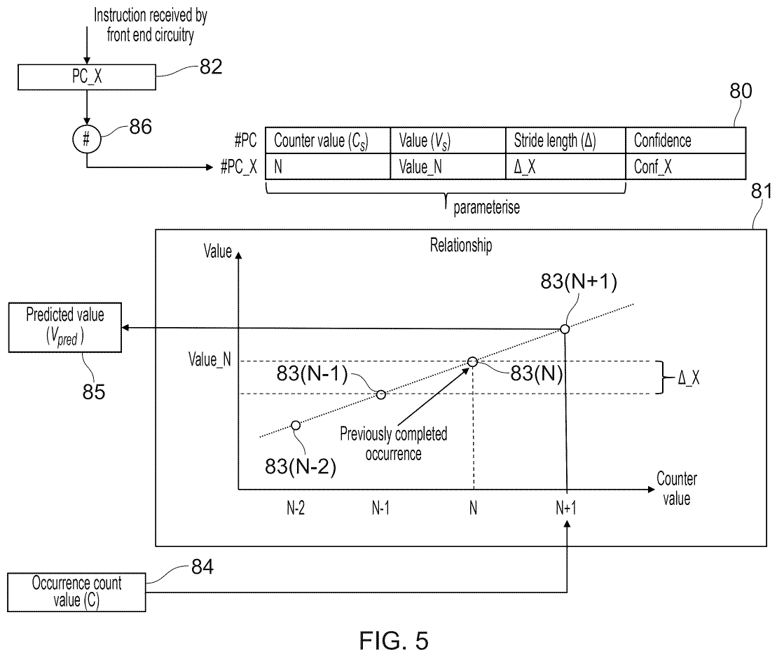

FIG. 5 schematically illustrates the parameterisation of a relationship 81 based on an instruction received by front end circuitry. In the illustrated example, the relationship 81 is a linear relationship of the form

V_{pred}=Vₛ+Δ×(C−Cₛ),

where V_{pred} is the value being predicted, Vₛ is a previously recorded value observed for a previous instance of the instruction, Δ is a stride length observed in relation to the instruction, Cₛ is a counter value at which the previously recorded value Vₛ was observed, and C is a current counter value. The relationship 81 is parameterised by the parameters Cₛ, Δ, and Vₛ which are stored, for a given instruction in a pattern entry 80 along with a confidence value indicative of a confidence in the pattern. The pattern entry 80 is identified based on a hash of the program counter value 82 of the given instruction. It is noted that whilst the illustrated configuration only shows a single pattern entry 80, an implementation may store 1 or a plurality of pattern entries.

The relationship 81 is a linear relationship between a predicted value (V_{pred}) 85 and an occurrence count value (C) 84. The form of the pattern entry 80 and the linear relationship 81 means that the predicted value 85 can be determined for any occurrence count value 84 regardless of whether the occurrence count value 84 follows sequentially from the previously observed counter value Cₛ, is separated from the previously observed counter value Cₛ by one or more other counter values, is identical to the previously observed counter value Cₛ, or occurs sequentially before the previously observed counter value Cₛ. For example, the relationship 81 defines a sequence of values 83 for a range of counter values. Whilst the illustrated configurations show the sequence of values for counter values in the range from N−2 to N+1, it will be readily apparent to the skilled person that the linear relationship could be linearly extended far beyond the illustrated range.

In order to make a prediction, the front end circuitry (comprising the prediction circuitry) receives a program counter value 82 indicative of a given instruction. The program counter value 82 is passed to hash circuitry 86 to generate a hash of the program counter value 82. The hash of the program counter value is used to lookup the pattern entry 80. Once the pattern has been identified, it is determined if the confidence value satisfies a minimum confidence threshold in order for the pattern entry to be used in prediction. In the illustrated configuration it is assumed that the confidence is sufficiently high. The pattern entry stores the previous counter value Cₛ, the stride length 4, and the value observed at the previous counter value Vₛ. The prediction circuitry parameterises the relationship 81 based on the parameters stored in the pattern entry 80. The relationship 81 is provided with a current occurrence count value 84, which in the illustrated configuration, is a value N+1, and outputs a predicted value 85 according to the relationship 81. The predicted value 85 can then be passed as a prediction to the processing circuitry to be used when processing the given instruction in advance of the value being resolved by the processing circuitry.

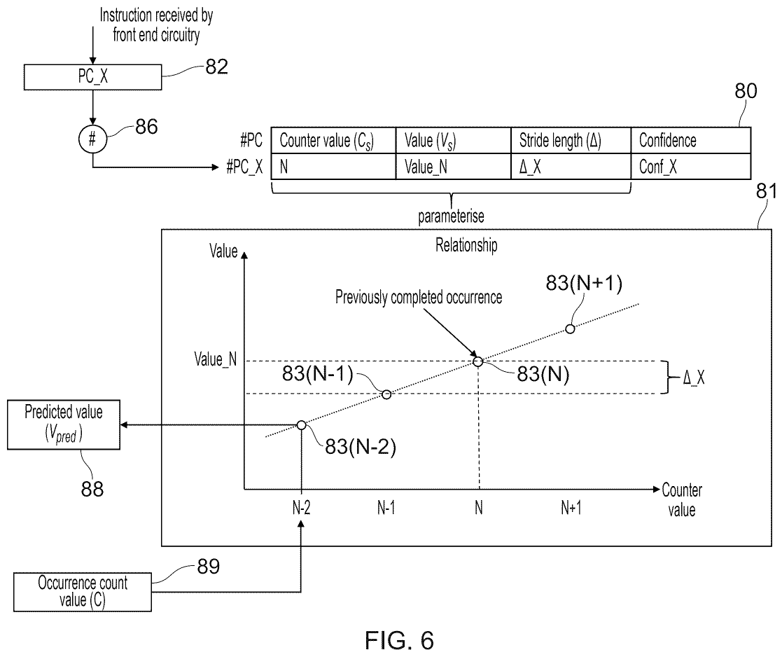

FIG. 6 schematically illustrates an alternative example which may occur after the processing pipeline has been flushed. The relationship 81, the pattern entry 80, and the program counter value 82 are the same as described in relation to FIG. 5. However, the occurrence count value 89 in this example is equal to N−2. As in FIG. 5, the program counter value 82 is passed to hash circuitry 86 to generate a hash of the program counter value 82. The hash of the program counter value is used to lookup the pattern entry 80. The pattern entry stores the previous counter value Cₛ, the stride length Δ, and the value observed at the previous counter value Vₛ. The prediction circuitry parameterises the relationship 81 based on the parameters stored in the pattern entry 80. The relationship 81 is provided with a current occurrence count value 89, which in the illustrated configuration, is a value N−2, and outputs a predicted value 88 according to the relationship 81. The predicted value 88 can then be passed as a prediction to the processing circuitry to be used when processing the given instruction in advance of the value being resolved by the processing circuitry.

It will be readily apparent to the person of ordinary skill in the art that the linear relationship described in FIGS. 5 and 6 is but one example of a possible relationship. The relationship could also be a periodically repeating piecewise linear relationship, a quadratic relationship, or a higher order polynomial relationship. In some configurations the relationship may be a non-algebraic relationship and may be additionally based on one or more other items of information available during instruction execution.

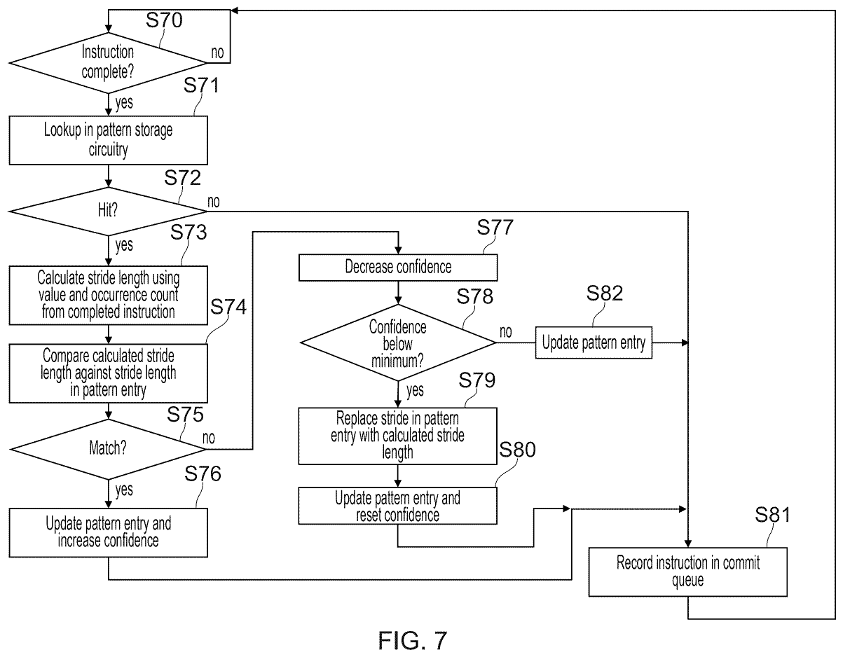

FIG. 7 schematically illustrates a sequence of steps carried out to maintain the prediction entries according to some configurations of the present techniques. Flow begins at step S70 where it is determined if an instruction has completed execution. If, at step S70, it is not determined that an instruction has completed, then flow remains at step S70. If, at step S70, it is determined that an instruction has completed, then flow proceeds to step S71 where a lookup is performed for the instruction in the pattern storage circuitry. Flow then proceeds to step S72 where it is determined if the lookup resulted in a hit in the pattern storage circuitry. If, at step S72, it is determined that there is no hit in the pattern storage circuitry, then flow proceeds to step S81 where the instruction is recorded in the commit queue before flow returns to step S70. If, at step S72, it is determined that the lookup resulted in a hit in the pattern storage circuitry, then flow proceeds to step S73 where a stride length is calculated using a value resulting from the completed instruction and an occurrence count from the completed instruction. In particular, the stride length is calculated by calculating a value difference between the value resulting from the completed instruction and a previous value stored in the pattern entry, calculating an occurrence count difference between the occurrence count value associated with the completed instruction and the occurrence count value stored in the pattern entry, and dividing the value difference by the occurrence count difference to obtain the stride length. Flow then proceeds to step S74 where the calculated stride length is compared against the stride length in the pattern entry. Flow then proceeds to step S75 where it is determined if the calculated stride length matches the stored stride length. If, at step S75, it is determined that there is a match, then flow proceeds to step S76 where the pattern entry is updated, for example, to update the occurrence count and the value, and a confidence value associated with the pattern entry is increased. Flow then proceeds to step S81 and continues as described above. If, at step S75, it was determined that there wasn't a match, then flow proceeds to step S77 where a confidence associated with the pattern entry is decreased. Flow then proceeds to step S78 where it is determined if the confidence is below a minimum confidence. If, at step S78, it is determined that the confidence is not below a minimum threshold, then flow proceeds to step S82 where the pattern entry is updated, for example, to update the occurrence count and the value. Flow then proceeds to step S81 and continues as described above. If, at step S78, it is determined that the confidence is below a minimum, then flow proceeds to step S79. At step S79 the stride length in the pattern entry is replaced by the calculated stride length. Flow then proceeds to step S80 where the pattern entry is updated, for example, to update the occurrence count and the value, and the confidence value associated with the pattern entry is reset to an initial value. Flow then proceeds to step S81 and continues as described above.

Whilst in some configurations the increase in the confidence at step S76 and the decrease in the confidence at step S77 may be symmetric, i.e., such that the confidence increase is of equal magnitude to the confidence decrease, in some configurations the confidence decrease at step S77 may be much greater than the confidence increase at step S76. In other words, a single occurrence of an instruction that hits on an entry but for which the calculated stride length is not equal to the stored stride length may result in the confidence being significantly reduced. In some configurations the confidence decrease at step S77 may be to reduce the confidence below the threshold or by an amount sufficient to reduce the confidence to the threshold such that a subsequent reduction in confidence would drop the confidence below the threshold.

It will be appreciated that if the initial lookup at step S71 results in a miss, then the apparatus may respond by causing a new pattern entry to be created in relation to the instruction. The new entry may be allocated into the pattern storage circuitry according to an allocation policy and may store an initial default stride length, for example, a stride length of zero. It will be appreciated that a stride length cannot be determined based on an initial observation of an instruction that does not have an associated entry in the pattern storage circuitry. Hence, an initial stride length of zero could be used in combination with the minimum confidence value such that the stride length is subsequently updated once a further occurrence of that instruction is received according to the steps set out in FIG. 7.

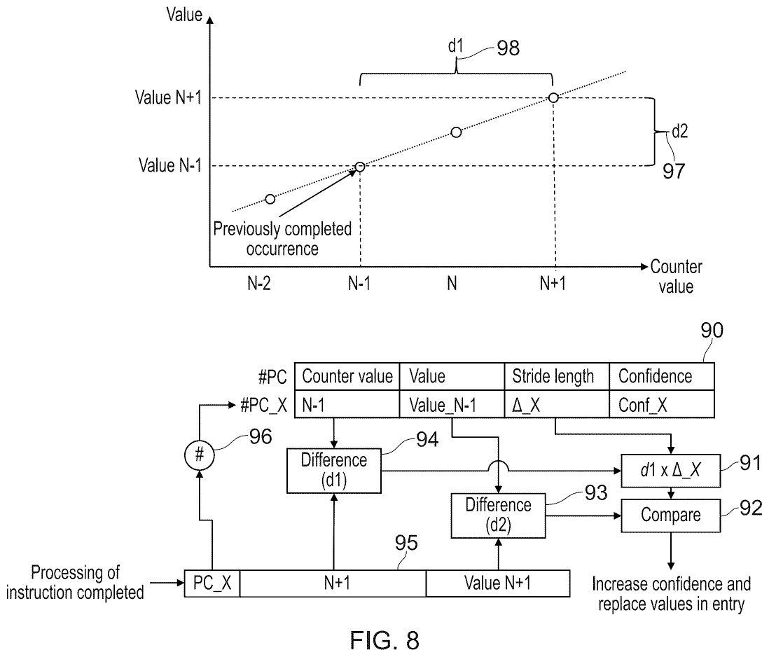

FIG. 8 schematically illustrates a first example of maintaining a pattern entry 90 according to some configurations of the present techniques. The pattern storage circuitry receives an indication 95 that processing of an instruction is complete. The indication 95 includes a program counter value to identify the instruction, a tag value identifying the counter value for that instance of the instruction (N+1 in the illustrated example), and the value produced for that instruction (Value N+1 in the illustrated example). The pattern storage circuitry passes the program counter value through hash circuitry 96 and performs a lookup based on the hashed program counter. The hashed program counter results in a pattern entry 90 which identifies a counter value, a value, a stride length, and a confidence. The pattern entry 90 includes parameters for parameterising a relationship, for example, as illustrated at the top of FIG. 8, defining a correlation between a counter value and a value. The pattern storage circuitry compares the counter value received in the indication 95 against the counter value stored in the pattern entry 90 using difference calculation circuitry 94. The difference calculation circuitry 94 determines an occurrence count difference d1 98. The pattern storage circuitry also compares the value stored in the indication 95 against the value stored in the pattern entry 90 using the difference calculation circuitry 93. The difference calculation circuitry 93 determines a value difference d2 97. The occurrence count difference d1 98 calculated by difference count circuitry 94 is passed to multiplication circuitry 91 along with the stride length Δ_X stored in the pattern storage 90. The multiplication circuitry calculates the product d1×Δ_X and passes the result to the comparison circuitry 92. The comparison circuitry compares the product d1×Δ_X against the value difference d2 97 calculated by the difference calculation circuitry d3. If the values match, then the completed instruction has behaved according to the relationship and the confidence in the relationship can be increased. If the values do not match then the completed instruction has not behaved according to the relationship and the confidence in the relationship is decreased. In the illustrated configuration, the calculated values match the values predicted by the relationship and the confidence in the pattern entry 90 is increased.

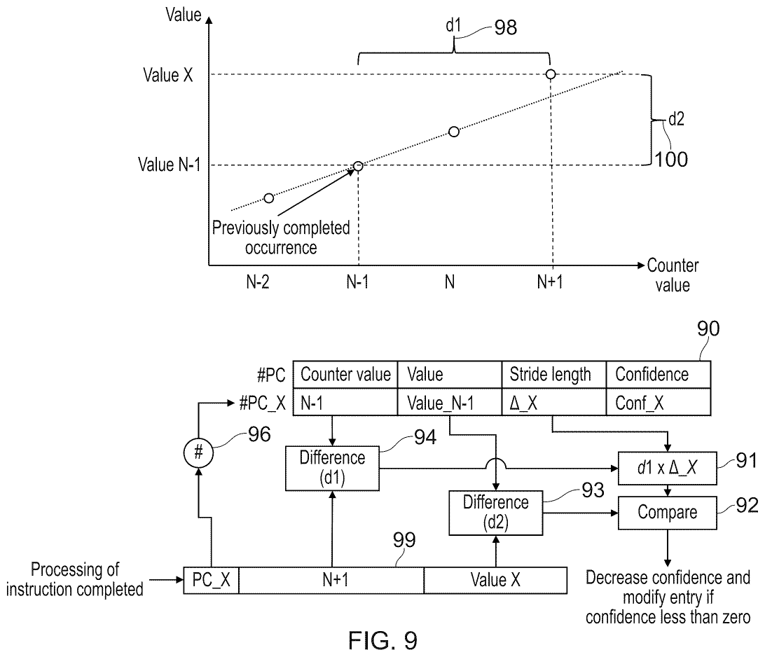

FIG. 9 schematically illustrates an alternative use case in which an indication of a completed instruction 99 is received and processed in the same manner as described in relation to FIG. 8. However, in contrast to FIG. 8, the value provided in the indication 99 (value X) is different to the predicted value. As a result, whilst difference d1 98 is the same as in FIG. 8, the difference d2 100 calculated by the difference calculation circuitry 93 is different to the value calculated by the multiplication circuitry 91. Hence, the comparison circuitry 92 determines that there is not a match and a confidence in the pattern entry 90 is decreased.

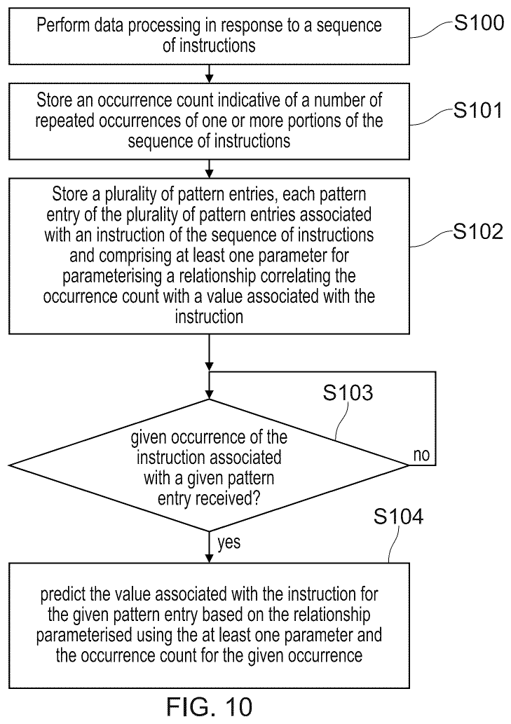

FIG. 10 schematically illustrates a sequence of steps carried out according to some configurations of the present techniques. Flow begins at step S100 where data processing is performed in response to a sequence of instructions. Flow then proceeds to step S101 where an occurrence count indicative of a number of repeated occurrences of one or more portions of the sequence of instructions is stored. Flow then proceeds to step S102 where a plurality of pattern entries is stored, each of the pattern entries associated with an instruction of the sequence of instructions and comprising at least one parameter for parameterising a relationship correlating the occurrence count with a value associated with the instruction. Flow then proceeds to step S103 where it is determined if a given occurrence of the instruction is associated with a given pattern entry has been received. If, at step S103, it is determined that no occurrence of the instruction associated with the given pattern entry has been received, then low remains at step S103. If, at step S103, it is determined that a given occurrence of the instruction associated with the given pattern entry has been received, then flow proceeds to step S104. At step S104 a value associated with the instruction for the given pattern entry is predicted based on the relationship parameterised using the at least one parameter and the occurrence count for the given occurrence.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

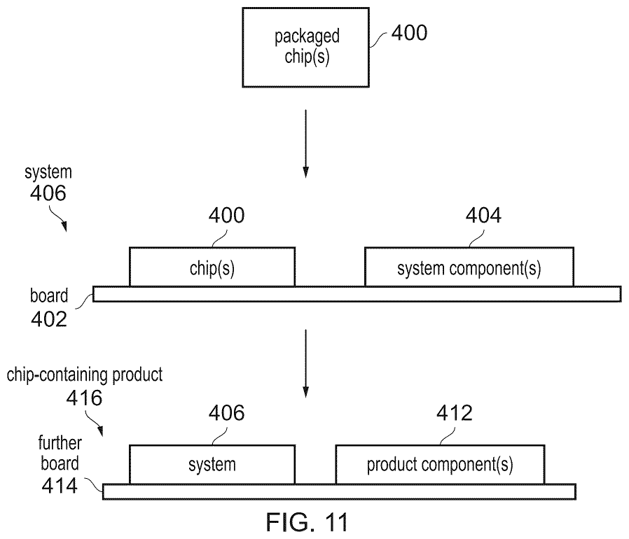

As shown in FIG. 11, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company. The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, System Verilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In brief overall summary there is provided an apparatus comprising processing circuitry to perform data processing in response to a sequence of instructions. The apparatus comprises occurrence count circuitry to store an occurrence count indicative of a number of repeated occurrences of portions of the sequence of instructions. The apparatus comprises pattern storage circuitry to store a plurality of pattern entries, each pattern entry of the plurality of pattern entries associated with an instruction of the sequence of instructions and comprising a parameter for parameterising a relationship correlating the occurrence count with a value associated with the instruction. The apparatus comprises prediction circuitry responsive to receipt of a given occurrence of the instruction associated with a particular pattern entry, to predict the value associated with the given occurrence based on the relationship parameterised using the at least one parameter comprised in the particular pattern entry and the occurrence count for the given occurrence

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: [A], [B] and [C]” encompasses any of the following options: A alone (without B or C), B alone (without A or C), C alone (without A or B), A and B in combination (without C), A and C in combination (without B), B and C in combination (without A), or A, B and C in combination.

Although illustrative configurations of the invention have been described in detail herein with reference to the accompanying drawings, it is to be understood that the invention is not limited to those precise configurations, and that various changes, additions and modifications can be effected therein by one skilled in the art without departing from the scope of the invention as defined by the appended claims. For example, various combinations of the features of the dependent claims could be made with the features of the independent claims without departing from the scope of the present invention.

Some configurations of the present techniques are described by the following numbered clauses:

Clause 1. An apparatus comprising:
processing circuitry configured to perform data processing in response to a sequence of instructions;
occurrence count circuitry configured to store an occurrence count indicative of a number of repeated occurrences of one or more portions of the sequence of instructions;
pattern storage circuitry configured to store a plurality of pattern entries, each pattern entry of the plurality of pattern entries associated with an instruction of the sequence of instructions and comprising at least one parameter for parameterising a relationship correlating the occurrence count with a value associated with the instruction; and
prediction circuitry responsive to receipt of a given occurrence of the instruction associated with a particular pattern entry of the plurality of pattern entries, to predict the value associated with the given occurrence of the instruction based on the relationship parameterised using the at least one parameter comprised in the particular pattern entry and the occurrence count for the given occurrence.

Clause 2. The apparatus of clause 1, wherein the processing circuitry comprises front end circuitry configured to receive the sequence of instructions in program order and to associate each instruction of the sequence of instructions with a tag value determined based on the occurrence count at the point at which that instruction is received.

Clause 3. The apparatus of clause 2, wherein the prediction circuitry is comprised in the front end circuitry.

Clause 4. The apparatus of clause 2 or clause 3, comprising recovery circuitry responsive to a flush of currently executing instructions from the processing circuitry, to restore the occurrence count value stored in the pattern storage circuitry to a restored occurrence count value determined based on the tag value associated with a sequentially first instruction to be issued for execution subsequent to the flush.

Clause 5. The apparatus of clause 4, wherein the prediction circuitry is configured to commence predicting when the sequentially first instruction is issued for execution.

Clause 6. The apparatus of any of clauses 2 to 5, wherein the processing circuitry is responsive to a completed instruction of the sequence of instructions, to perform a lookup in the pattern storage circuitry based on the completed instruction and, in response to the lookup resulting in a hit in the pattern storage circuitry, to update the at least one parameter comprised in the pattern entry that resulted in the hit.

Clause 7. The apparatus of clause 6, wherein the at least one parameter comprises at least one of:
the tag value associated with the completed instruction; and
the value associated with the completed instruction.

Clause 8. The apparatus of any preceding clause, wherein the relationship is suitable for predicting, as the value, a new value not included in a set of previously observed values associated with the instruction.

Clause 9. The apparatus of clause 8, wherein the relationship is suitable for extrapolating the new value beyond a range of the previously observed values.

Clause 10. The apparatus of any preceding clause, wherein the relationship is suitable for extrapolating the value over at least one occurrence count value beyond occurrence count values previously stored in the occurrence count circuitry.

Clause 11. The apparatus of any preceding clause, wherein the relationship comprises a mathematical relationship between the occurrence count and the value.

Clause 12. The apparatus of clause 11, wherein the mathematical relationship is a linear relationship.

Clause 13. The apparatus of clause 12, wherein the linear relationship comprises a linearization about a previously observed occurrence of the instruction associated with the particular pattern entry.

Clause 14. The apparatus of clause 12 or clause 13, wherein the prediction circuitry is stride prediction circuitry and the linear relationship has a gradient equal to an observed stride length between consecutive occurrences of the instruction.

Clause 15. The apparatus of any preceding clause, wherein the at least one parameter comprises a correlation between a previous value associated with a previous occurrence of the instruction and a previous occurrence count associated with the previous occurrence.

Clause 16. The apparatus of any preceding clause, wherein the occurrence count circuitry is configured to increment the occurrence count in response to a detection of a backwards change of program flow indicative of a change of program flow from a first instruction to a second instruction having a lower instruction address than the first instruction.

Clause 17. The apparatus of any preceding clause, wherein the instruction is a memory access instruction and the value is one of:
at least a portion of an address to be used by the memory access instruction to retrieve content from memory; and
content to be loaded in response to the memory access instruction.

Clause 18. A system comprising:
the apparatus of any preceding clause, implemented in at least one packaged chip;
at least one system component; and
a board,
wherein the at least one packaged chip and the at least one system component are assembled on the board.

Clause 19. A chip-containing product comprising the system of clause 18, wherein the system is assembled on a further board with at least one other product component.

Clause 20. A method comprising:
performing data processing in response to a sequence of instructions;
storing an occurrence count indicative of a number of repeated occurrences of one or more portions of the sequence of instructions;
storing a plurality of pattern entries, each pattern entry of the plurality of pattern entries associated with an instruction of the sequence of instructions and comprising at least one parameter for parameterising a relationship correlating the occurrence count with a value associated with the instruction; and
in response to receipt of a given occurrence of the instruction associated with a particular pattern entry of the plurality of pattern entries, predicting the value associated with the given occurrence of the instruction based on the relationship parameterised using the at least one parameter comprised in the particular pattern entry and the occurrence count for the given occurrence.

Clause 21. A non-transitory computer-readable medium storing computer-readable code for fabrication of the apparatus according to any of clauses 1 to 17.

We claim:

1. An apparatus comprising:
processing circuitry configured to perform data processing in response to a sequence of instructions;
occurrence count circuitry configured to store an occurrence count indicative of a number of repeated occurrences of one or more portions of the sequence of instructions;
pattern storage circuitry configured to store a plurality of pattern entries, each pattern entry of the plurality of pattern entries associated with an instruction of the sequence of instructions and comprising at least one parameter for parameterising a relationship correlating the occurrence count with a value associated with the instruction; and
prediction circuitry responsive to receipt of a given occurrence of the instruction associated with a particular pattern entry of the plurality of pattern entries, to predict the value associated with the given occurrence of the instruction based on the relationship parameterised using the at least one parameter comprised in the particular pattern entry and the occurrence count for the given occurrence.

2. The apparatus of claim 1, wherein the processing circuitry comprises front end circuitry configured to receive the sequence of instructions in program order and to associate each instruction of the sequence of instructions with a tag value determined based on the occurrence count at the point at which that instruction is received.

3. The apparatus of claim 2, wherein the prediction circuitry is comprised in the front end circuitry.

4. The apparatus of claim 2, comprising recovery circuitry responsive to a flush of currently executing instructions from the processing circuitry, to restore the occurrence count value stored in the pattern storage circuitry to a restored occurrence count value determined based on the tag value associated with a sequentially first instruction to be issued for execution subsequent to the flush.

5. The apparatus of claim 4, wherein the prediction circuitry is configured to commence predicting when the sequentially first instruction is issued for execution.

6. The apparatus of claim 2, wherein the processing circuitry is responsive to a completed instruction of the sequence of instructions, to perform a lookup in the pattern storage circuitry based on the completed instruction and, in response to the lookup resulting in a hit in the pattern storage circuitry, to update the at least one parameter comprised in the pattern entry that resulted in the hit.

7. The apparatus of claim 6, wherein the at least one parameter comprises at least one of:
the tag value associated with the completed instruction; and
the value associated with the completed instruction.

8. The apparatus of claim 1, wherein the relationship is suitable for predicting, as the value, a new value not included in a set of previously observed values associated with the instruction.

9. The apparatus of claim 8, wherein the relationship is suitable for extrapolating the new value beyond a range of the previously observed values.

10. The apparatus of claim 1, wherein the relationship is suitable for extrapolating the value over at least one occurrence count value beyond occurrence count values previously stored in the occurrence count circuitry.

11. The apparatus of claim 1, wherein the relationship comprises a mathematical relationship between the occurrence count and the value.

12. The apparatus of claim 11, wherein the mathematical relationship is a linear relationship.

13. The apparatus of claim 12, wherein the prediction circuitry is stride prediction circuitry and the linear relationship has a gradient equal to an observed stride length between consecutive occurrences of the instruction.

14. The apparatus of claim 1, wherein the at least one parameter comprises a correlation between a previous value associated with a previous occurrence of the instruction and a previous occurrence count associated with the previous occurrence.

15. The apparatus of claim 1, wherein the occurrence count circuitry is configured to increment the occurrence count in response to a detection of a backwards change of program flow indicative of a change of program flow from a first instruction to a second instruction having a lower instruction address than the first instruction.

16. The apparatus of claim 1, wherein the instruction is a memory access instruction and the value is one of:
at least a portion of an address to be used by the memory access instruction to retrieve content from memory; and
content to be loaded in response to the memory access instruction.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17, wherein the system is assembled on a further board with at least one other product component.

19. A method comprising:
performing data processing in response to a sequence of instructions;
storing an occurrence count indicative of a number of repeated occurrences of one or more portions of the sequence of instructions;
storing a plurality of pattern entries, each pattern entry of the plurality of pattern entries associated with an instruction of the sequence of instructions and comprising at least one parameter for parameterising a relationship correlating the occurrence count with a value associated with the instruction; and
in response to receipt of a given occurrence of the instruction associated with a particular pattern entry of the plurality of pattern entries, predicting the value associated with the given occurrence of the instruction based on the relationship parameterised using the at least one parameter comprised in the particular pattern entry and the occurrence count for the given occurrence.

20. A non-transitory computer-readable medium storing computer-readable code for fabrication of an apparatus comprising:
processing circuitry configured to perform data processing in response to a sequence of instructions;
occurrence count circuitry configured to store an occurrence count indicative of a number of repeated occurrences of one or more portions of the sequence of instructions;
pattern storage circuitry configured to store a plurality of pattern entries, each pattern entry of the plurality of pattern entries associated with an instruction of the sequence of instructions and comprising at least one parameter for parameterising a relationship correlating the occurrence count with a value associated with the instruction; and
prediction circuitry responsive to receipt of a given occurrence of the instruction associated with a particular pattern entry of the plurality of pattern entries, to predict the value associated with the given occurrence of the instruction based on the relationship parameterised using the at least one parameter comprised in the particular pattern entry and the occurrence count for the given occurrence.
